(19) United States
(12) Patent Application Publication
(10) Pub. No.: US 2005/0243120 A1
(43) Pub. Date: Nov. 3, 2005

(54) Method for calibrating a write head for producing a printing plate

(75) Inventors: Andreas Detmers, Heddesheim (DE); Hans Kohler, Edingen (DE); Michael Muller, Neckargemund (DE)

Correspondence Address: LERNER AND GREENBERG, PA, P O BOX 2480, HOLLYWOOD, FL, 33022-2480, US

(73) Assignee: Heidelberger Druckmaschinen AG

(21) Appl. No.: 11/065,666

(22) Filed: Feb. 24, 2005

(30) Foreign Application Priority Data
Apr. 30, 2004 (DE) 10 2004 021 326.7

(51) Int. Cl. B41J 29/393

(52) U.S. Cl. 347/19

(57) ABSTRACT

A write head of an imaging system for producing a printing plate can be calibrated quickly, simply and without errors. Test patterns are produced with the write head, the deviation of a property of the write head from a reference value is determined, and a corrective parameter in the write head is adjusted in order to compensate for the deviation. Test patterns that can be evaluated visually with regard to the writing quality are produced in a plurality of test fields with different parameter values, an identifier that can be picked up visually is produced with each test field, and the identifier of the test field which appears best in terms of quality is entered into a control device for the write head. The printing plate is produced by using the entry of the identifier for automatically setting the parameter value with which the best test field was produced.

### BACKGROUND OF THE INVENTION

### Field of the Invention

The invention lies in the printing technology field. More specifically, the invention relates to a method of calibrating a write head for producing a printing plate. By using test patterns produced with the write head, the deviation of a property of the write head from a reference value is determined, and a corrective parameter in the write head is adjusted in order to compensate for the deviation.

In order to achieve a short imaging time, in imaging systems a plurality of imaging heads are used simultaneously. Each imaging head images a subregion on a printing plate blank. In prior art imaging systems, a plurality of imaging heads are mounted on a carriage which can be displaced parallel to the axis of a printing plate cylinder. Each imaging head contains at least one radiation source whose emission direction should point exactly perpendicularly at the axis of rotation of the printing plate cylinder. Errors in the mounting of an imaging head result in errors in the printed image to be produced. For example, overlapping lines or non-imaged strips can be produced between two subregions. In the case of imaging heads with individual emitters arranged along a line, errors occur if an individual emitter is not in line or the reference line of the individual emitter does not run parallel to the axis of rotation of a printing plate cylinder. Zigzag edges then manifest themselves in the printed image.

In order to avoid or reduce imaging errors, the imaging systems are calibrated. It is known to determine corrective values by using test exposures and, by using the corrective values, to perform mechanical, electronic or programming adjustments to the imaging system. For instance, imaging heads can be aligned on a carriage, the power of the radiation sources can be adjusted or the time of activation of the radiation sources can be changed. In order to determine the corrective values, the test exposures are measured. Measuring instruments are used to determine the extent to which a position or dimension of an element from a test field deviates from predefined variables. For this purpose, the test field can be evaluated directly on a printing plate or its image can be evaluated after being printed on a printing material. If the measurements are carried out by an operator, then there is the risk of subjective measurement errors and errors in the calibration of an imaging system. If, for example, an imaging head having radiation sources arranged along a line has a skewed position, then by using a test exposure, the angle by which the imaging head is tilted with respect to the axis of rotation of a printing plate cylinder is measured. The angular measurement may be carried out only with finite accuracy. If the imaging head provides electronic correction in the form of a delay of the activation of individual radiation sources in 1/16 of the dimensions of an image point, then, by using the angular deviations, the operator has to define how the delay of each individual channel has to be adjusted in order to compensate for the skewed position of the imaging head. These adjustments made by a person are inaccurate and time-consuming.

German published patent application DE 102 15 694 A1 describes a method for producing a printing plate in which a test image is produced in a non-subject region and is evaluated with a reader and a computer. The manner in which the correction and setting values for subsequent imaging in the useful subject region are derived is not disclosed in detail.

In a production method for a printing plate according to international PCT publication WO 92/12011 (cf. DE 69 212 801 T2), test prints, which are measured, are produced with a test printing plate. In that case, the position deviations of image points are determined. From the position deviations of the image points, corrective values in two coordinates are stored in the form of a table. The stored corrective values are used as a function of position during the imaging of printing plates. Measuring a test print point by point is time-consuming.

### SUMMARY OF THE INVENTION

It is accordingly an object of the invention to provide a method of calibrating a print head for producing a printing plate which overcomes the above-mentioned disadvantages of the heretofore-known devices and methods of this general type and which renders it possible to adjust an imaging system quickly, simply and without errors by using test exposures.

With the foregoing and other objects in view there is provided, in accordance with the invention, a method for calibrating a write head for producing a printing plate, which comprises:

producing test patterns configured for visual evaluation with regard to a writing quality in a plurality of test fields with different parameter values;

producing visually detectable identifiers with each test field;

determining a test field that appears best in terms of quality and entering the identifier of the test field that appears best into a control device for the write head; and

automatically setting, in accordance with the entered identifier, a parameter value with which the test field that appears best was produced, for producing the printing plate.

In other words, first of all test patterns that can be assessed visually are produced with various parameter values. In each test field, a possible value of a corrective variable is used which is suitable for correcting an adjustable property. The test field in which the correction (i.e., parameter variation) functions best or has the best visually detected result, is determined the best test field. For the purpose of visual assessment, an operator can use optical aids, such as a magnifying glass. Each test field contains a criterion which can be seen easily and which permits selection as the best test field. All the test fields are provided with an indicator. In a simple case, the test fields are numbered consecutively, so that a number of the best test field can be read off. In addition to numbers, letters, symbols or color markings can also be used as indicators. The number of the best test field is entered into a control system of the imaging system. The controlling software makes an allocation of the indicator entered to a parameter value with which the best test field was produced. For subsequent imaging operations, this parameter value is automatically used. The invention can be used in external plate exposers and in imaging systems which are integrated into a press.

In accordance with an added feature of the invention, the write head is a head with a plurality of laser diodes mounted along a straight line, and the method further comprises calibrating a deviation of the holder of the write head by producing linear test fields having an orientation with respect to the straight line associated with a directional or angular error of the write head.

In accordance with an additional feature of the invention, the identifiers are mutually different numbers and/or letter combinations and they are produced in a surrounding of the associated test fields.

In accordance with another feature of the invention, the test fields are produced in a series with parameters changed step by step.

In accordance with a concomitant feature of the invention, the visually assessable test fields are produced on a test printing plate.

Once more in summary, the method permits an imaging system to be adjusted quickly, simply and without errors by using test exposures. In a method for calibrating a write head for producing a printing plate, in which, by using test patterns produced with the write head, the deviation of a property of the write head from a reference value is determined, and in which a corrective parameter in the write head is adjusted in order to compensate for the deviation, the invention consists in that test patterns that can be evaluated visually with regard to the writing quality are produced in a plurality of test fields with different parameter values, an identifier that can be picked up visually is produced with each test field, the identifier of the test field which appears best in terms of quality is entered into a control device for the write head, and, in order to produce the printing plate by using the entry of the identifier, the parameter value with which the test field that appears best in terms of quality was produced is set automatically.

Other features which are considered as characteristic for the invention are set forth in the appended claims.

Although the invention is illustrated and described herein as embodied in a method for calibrating a write head for producing a printing plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of an imaging system having four imaging heads;

FIG. 2 is a developed view of a printing plate blank having correctly produced imaging regions;

FIG. 3 is a developed view of a printing plate blank having imaging regions with zigzag edges;

FIG. 4 is a plan view of an arrangement of test patterns for tilt calibration;

FIG. 5 illustrates a development of a printing plate blank having laterally offset imaging regions;

FIG. 6 is a plan view of an arrangement of test patterns for module spacing calibration;

FIG. 7 illustrates a development of a printing plate blank having imaging regions that are offset in the circumferential direction; and

FIG. 8 is a plan view of an arrangement of test patterns for vertical calibration.

### DESCRIPTION OF THE PREFERRED EMBODIMENTS

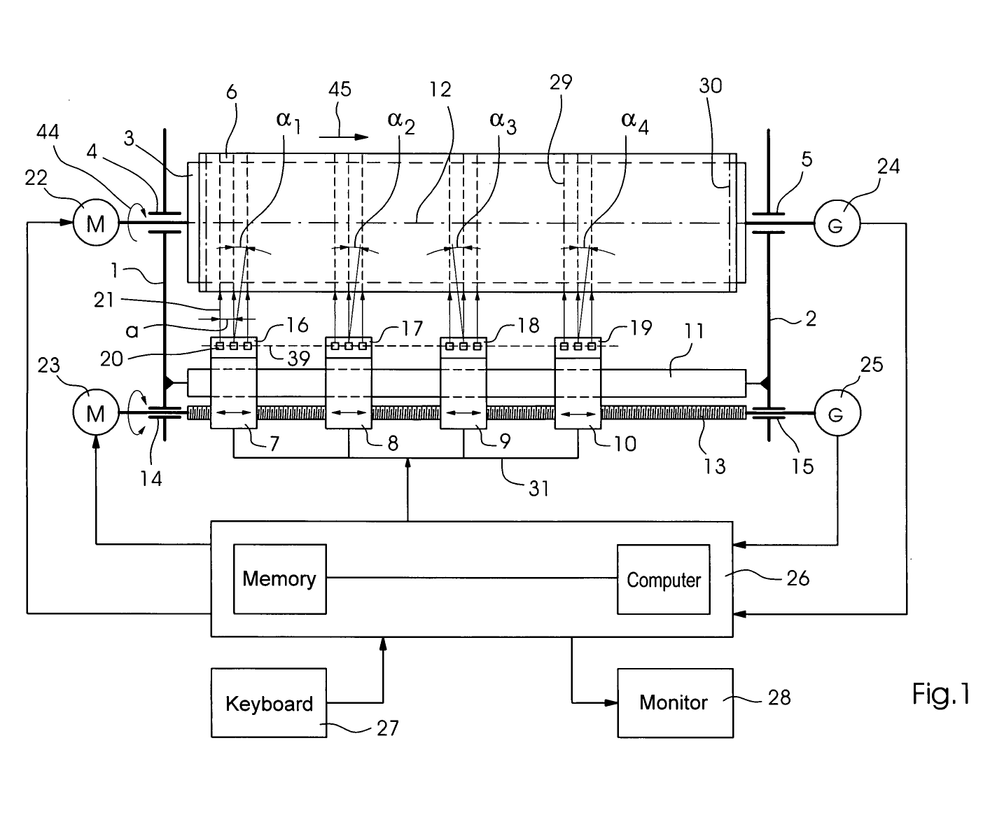

Referring now to the figures of the drawing in detail and first, particularly, to FIG. 1 thereof, there is shown a schematic drawing of an imaging system which is integrated in a printing press. A printing plate cylinder 3 is held in bearings 4, 5 such that it can rotate between the side walls 1, 2. A printing plate blank 6 is clamped on the printing plate cylinder 3. In order to produce easily visible test image points on the surface of the printing plate blank 6, four imaging heads 7-10 are provided. The imaging heads 7-10 are disposed on a longitudinal guide 11. The imaging heads 7-10 can be positioned jointly by a spindle drive 13 in the direction of the axis of rotation 12. The spindle drive 13 is rotatably mounted in bearings 14, 15 in the side walls 1, 2 respectively.

The imaging heads 7-10 contain laser diode arrays 16-19 including optically projecting elements and control technology. A laser diode array 16-19 comprises 64 individually activated laser diodes 20 which are aligned along a line parallel to the axis of rotation 12. A spacing distance a of the laser diodes 20 in the direction parallel to the axis of rotation 12 is greater than the minimum spacing of two image points to be produced. When a laser diode 20 is activated, a laser beam 21 orthogonal to the axis of rotation 12 is produced.

The printing plate cylinder 3 and the spindle drive 13 are in each case coupled to motors 22, 23 and rotary encoders 24, 25. The imaging heads 7-10, the motors 22, 23 and the rotary encoders 24, 25 are connected to a control device 26. The control device 26 contains computing means for controlling the press during printing and during imaging. The keyboard 27 permits the entry of data by an operator. A monitor is used to display control information.

The laser diode arrays 16-19 have mounting errors, so that the laser beams 21 are emitted at an angle to the axis of rotation 12. In the common plane of the laser diodes 20 and the axis of rotation 12, the laser diode arrays 16-19 have, for example, angular deviations α₁ to α₄. The printing plate blank 6 is imaged in accordance with what is known as the interleave method, as described in German published patent application DE 101 08 624 A1 and the corresponding publications U.S. Pat. No. 6,765,604 B2 and US 2002/0154207 A1. By means of suitable selection of the advance of the laser diode arrays 16-19 in the direction of the axis of rotation 12, test imaging without gaps can be achieved after traveling over a marginal region. Each laser diode array 16-19 produces screen or image points in a subregion of the printing image region 30 along lines 29 running in the circumferential direction of the printing plate cylinder 3.

The imaging heads 7-10 and the laser diode arrays 16-19 are connected to one another via a data line 31. The data items are placed one after another on the data line 31, the control technology of the laser diode arrays 16-19 extracting the respective data items from the data stream. The data items for activating the laser diode arrays 16-19 are organized in the form of data packets, so that in each case 64 bits for the 64 laser diodes 20 are sent to a laser diode array 16-19.

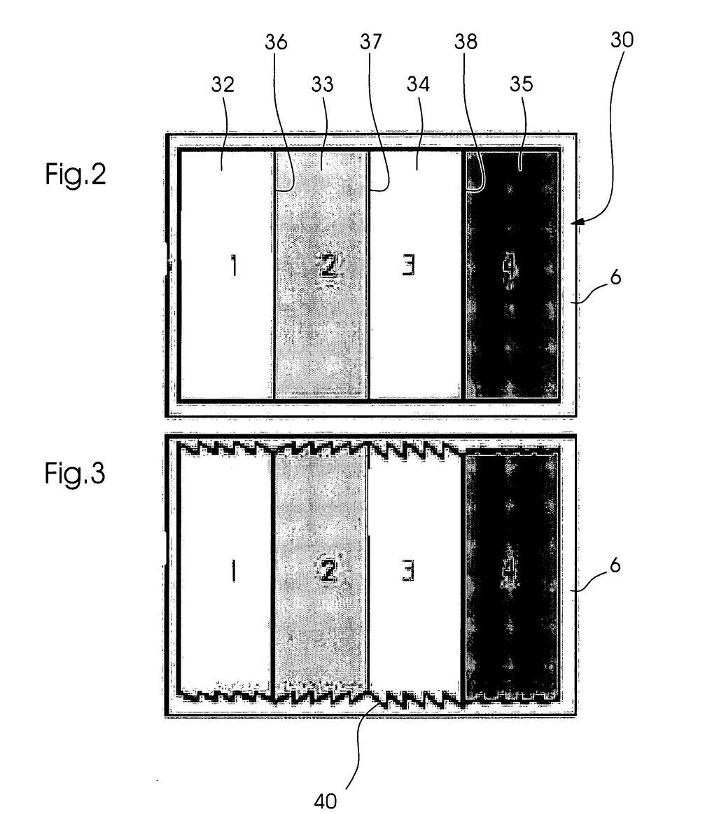

FIG. 2 shows imaging regions 32-35 on a printing plate blank 6 which are produced by the imaging heads 7-10 given an ideal alignment. In the boundary regions 36-38, the lines 29 are located such that there are no overlaps or unexposed strips. The external contour of the printing image region 30 formed from the individual imaging regions 32-35 runs exactly in the shape of a rectangle.

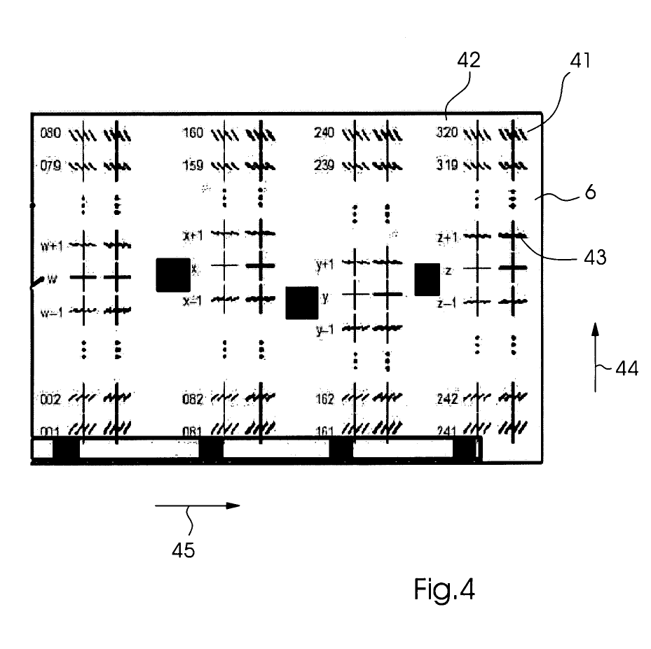

The compensation of the skewed position of the laser diode arrays 16-19 is to be described by using FIGS. 3 and 4. A skewed position of the laser diode arrays 16-19 results if the laser diodes 20 are arranged on a straight line 39 (FIG. 1) lying obliquely with respect to a plane which contains the axis of rotation 12 of the printing plate cylinder 3 and the direction of the laser beams 21 running at right angles thereto. A skewed position of the laser diode arrays 16-19 results in the imaging regions 32-35 shown in FIG. 3. As a result of the tilting of the laser diode arrays 16-19 about the aforesaid plane, zigzags 40 result at the upper and lower edges of the imaging regions 32-35. In order to avoid the zigzags 40, the tilting of the laser diode arrays 16-19 must be compensated for. For this purpose, test fields 41 with an associated number 42 are produced on a printing plate blank 6 by each laser diode array 16-19, as illustrated in FIG. 4. In each test field 41, a horizontal line 43 is imaged. In each test field 41, a different electronic delay of the individual channels of the laser diode arrays 16-19 is set, so that the result is virtual tilting of the laser diode arrays 16-19, which manifests itself in a skewed position of the lines 43 on the printing plate blank 6. As viewed in the circumferential direction 44 of the printing plate blank 6, the laser diodes 20 of the laser diode arrays 16-19 experience linearly rising and falling turn-on delays along the lateral direction 45. The numbers 42 of the test fields 41 which are produced with the laser diodes 16-19 lie in various value ranges w, x, y, z, with w=001-080, x=081-160, y=161-240 and z=241-320. By means of a magnifying glass, the test field 41 which has a line 43 which is produced continuously without discontinuities is determined visually. The lines 43 are in each case produced twice with different line thicknesses. The thicker lines 43 can be used for a first orientation. The relevant number 42 of the best test field 41 is then determined by using the thin lines 43. The number w, x, y, z of the line 43 which actually appears as a continuous horizontal line 43 on the printing plate blank 6 is determined for each laser diode array 16-19 and entered into the control device 26 via the keyboard 27. By using the numbers w, x, y, z, values for the electronic delay in the activation of the laser diodes 20 of the laser diode arrays 16-19 are determined with a program and stored for future imaging operations.

In this method, it is not necessary for an operator to know the actual skewed position of the laser diodes 16-19. Therefore, subjective errors in determining and reading the skewed position are ruled out. The operator does not have to calculate any corrective values either since this is done automatically by a computer in the control device 26 after the numbers 42 of the best test field 41 have been entered.

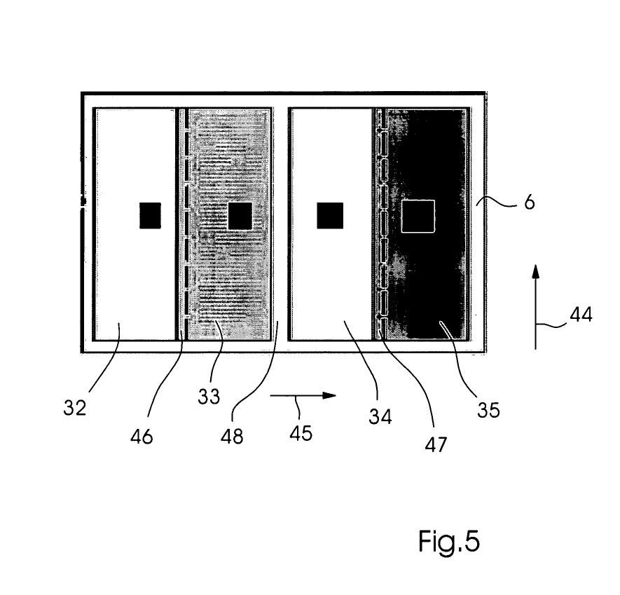

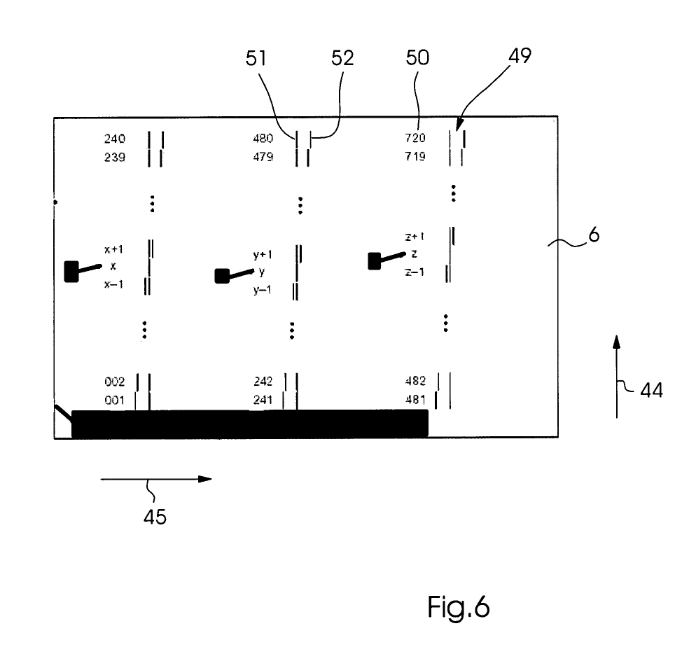

The laser diode arrays 16-19 always have positioning errors in the lateral direction 45 following mounting. As a result, the imaging regions 32-35 are displaced in the lateral direction 45, as shown in FIG. 5. Overlaps 46, 47 form between the imaging regions 32, 33 and 34, 35. A non-imaged strip 48 is produced between the imaging regions 33, 34. In order to calibrate the spacing of the laser diode arrays 16-19 in the lateral direction 45, test imaging is carried out on a printing plate blank, as illustrated in FIG. 6. The test image contains three groups of test fields 49 located in the circumferential direction 44, each test field 49 being assigned a number 50. Each group of test fields 49 is used to calibrate the spacing of the laser diode arrays 16-19 in the boundary regions 36-38. A test field 49 consists of two lines 51, 52 located in the circumferential direction 44, which are each produced by adjacent laser diode arrays 16, 17; 17, 18; 18, 19. In each test field group, the spacing of the lines 51, 52 is reduced and increased step by step by means of delayed activation of the laser diodes 20 in the lateral direction 45. Using a magnifying glass, the test field 49 in which the two lines 51, 50 lie above each other is determined visually for all the test field groups. As described in the case of the tilt calibration, the numbers x, y, z of the test fields in which the lines 51, 52 lie above each other are entered into the control device 26 via the keyboard 27. The values for the delayed activation of the laser diodes 20 in the lateral direction 45 are given automatically by the numbers x, y, z from different value ranges. The values are stored for future imaging operations.

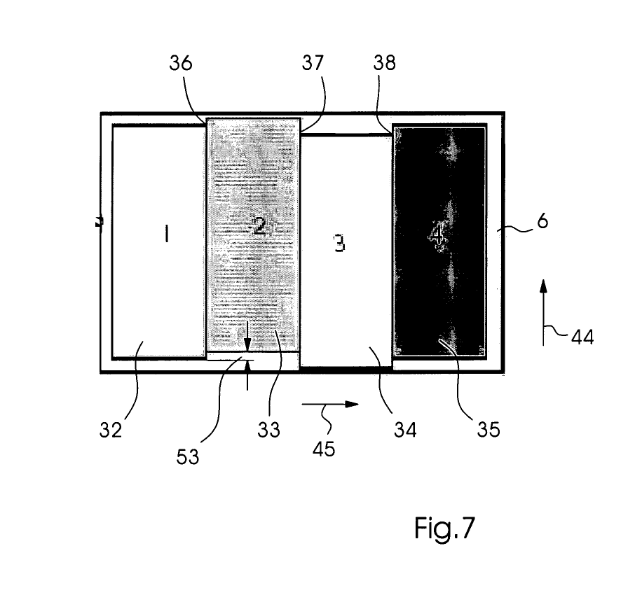

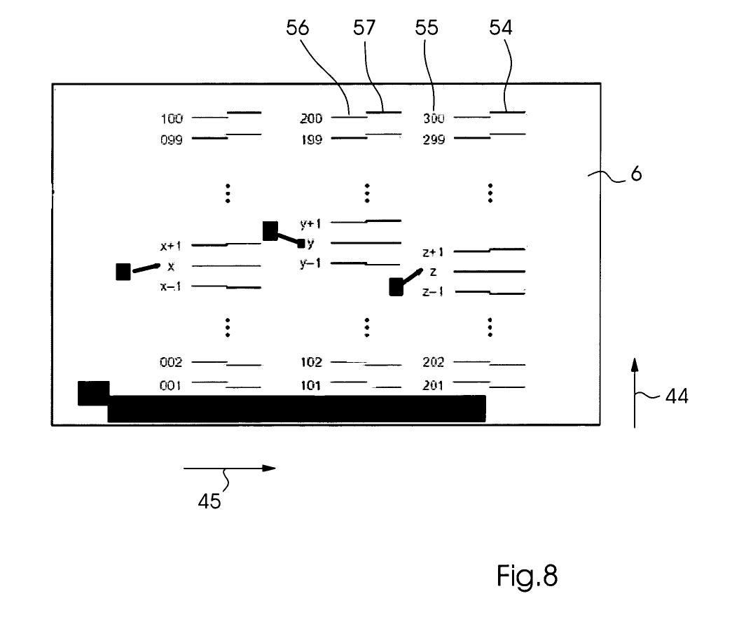

In FIG. 7, imaging regions 32-35 offset from one another in the circumferential direction 44 are illustrated. An offset 53 in the circumferential direction 44 arises when a laser diode array 16-19 is vertically too high or too low with respect to another laser diode array 16-19. In order to calibrate an offset 53, a test exposure, shown in FIG. 8, is made on a printing plate blank 6. The test imaging contains three groups of test fields 54 located in the circumferential direction 44, each test field 54 being assigned a number 55. Each test field group is used to calibrate the vertical position of one of the laser diode arrays 16-19. A test field 54 consists of two lines 56, 57 located in the lateral direction 45, which are each produced by two adjacent laser diode arrays 16, 17; 17, 18; 18, 19. In each test field group, the spacing of the lines 56, 57 is reduced and increased step by step by means of delayed activation of the laser diodes 20 in the circumferential direction 44. The test fields in which the lines 56, 57 are aligned are determined with a magnifying glass. The numbers 55 of these test fields 54 are entered into the control device 26 via the keyboard 27. As in the case of the calibrations already described, the correct values for the delay of the activation of the laser diodes 20 in the circumferential direction are stored automatically for future imaging operations.

The tilt calibration with the test fields 41 according to FIG. 4, the spacing calibration with the test fields 49 according to FIG. 6, and the vertical calibration with the test fields 54 according to FIG. 8 are expediently carried out one after another in the order mentioned. The test fields 41, 49, 54 can be arranged on a printing plate blank in such a way that only one printing plate blank 6 is needed for all the calibrations.

This application claims the priority, under 35 U.S.C. § 119, of German patent application No. 10 2004 021 326.7, filed Apr. 30, 2004; the entire disclosure of the prior application is herewith incorporated by reference.

1. A method for calibrating a write head for producing a printing plate, which comprises:
producing test patterns configured for visual evaluation with regard to a writing quality in a plurality of test fields with different parameter values;
producing visually detectable identifiers with each test field;
determining a test field that appears best in terms of quality and entering the identifier of the test field that appears best into a control device for the write head; and
automatically setting, in accordance with the entered identifier, a parameter value with which the test field that appears best was produced, for producing the printing plate.

2. The method according to claim 1, wherein the write head is a head with a plurality of laser diodes mounted along a straight line, and the method further comprises calibrating a deviation of the holder of the write head by producing linear test fields having an orientation with respect to the straight line associated with a directional or angular error of the write head.

3. The method according to claim 1, which comprises producing identifiers selected from the group consisting of mutually different numbers and letter combinations of the test field in each case in a surrounding of the test fields.

4. The method according to claim 1, which comprises producing the test fields in a series with parameters changed step by step.

5. The method according to claim 1, which comprises producing visually assessable test fields on a test printing plate.

6. A method for calibrating a write head for producing a printing plate, which comprises:
producing test patterns with a variety of different parameter values in a plurality of test fields with the write head, and producing identifiers associated with each test field;
visually inspecting the test fields and selecting from the plurality of test fields a best test field that appears best in terms of quality; and
entering the identifier associated with the best test field into a control device for the write head and compensating for a deviation of the write head by automatically setting, in accordance with the entered identifier, a parameter value with which the best test field was produced, for producing the printing plate.
